(19) United States
(12) Patent Application Publication
(10) Pub. No.: US 2021/0138432 A1
(43) Pub. Date: May 13, 2021

(54) PROCESS FOR PREPARING A METAL-ORGANIC FRAMEWORK

(71) Applicant: MOF Technologies Limited, Belfast (GB)

(72) Inventors: John BREEN, Belfast (GB); Jose CASABAN-JULIAN, Belfast (GB); Conor HAMILL, Belfast (GB); Mark GARRETT, Belfast (GB); Stuart JAMES, Belfast (GB)

(73) Assignee: MOF Technologies Limited, Belfast (GB)

(21) Appl. No.: 16/492,447

(22) PCT Filed: Mar. 8, 2018
(86) PCT No.: PCT/GB2018/050585

§ 371 Date: Sep. 9, 2019

(30) Foreign Application Priority Data
Mar. 10, 2017 (GB) 1703879.5

(51) Int. Cl. B01J 20/22; B01J 20/30

(52) U.S. Cl. CPC B01J 20/226; B01J 20/3007; B01J 20/3078; B01J 20/3021

(57) ABSTRACT

The present invention relates to a process for preparing a magnesium formate based metal-organic framework. The process comprises (a) combining magnesium or magnesium oxide with formic acid; (b) heating the reaction mixture of step (a) at a temperature of between 70° C. and 200° C.; (c) combining formic acid with the reaction mixture of step (b); and (d) heating the reaction mixture of step (c) at a temperature of between 70° C. and 200° C. Steps (c) and (d) may be heated up to 5 times.

The present invention relates to processes for preparing magnesium formate-based metal-organic framework materials.

Metal-organic frameworks, hereinafter ‘MOFs’, are crystalline or non-crystalline, porous metal-organic compounds, having particular pore sizes or pore distributions and large specific surface areas. They also have low bulk volumes due to their porosity, making them extremely light. MOFs have therefore become the focus of intense research in recent years, due to their potential applications in the fields of gas storage, carbon capture, separation, drug storage and delivery, and sensors, among others.

A major barrier to the large scale commercialisation of MOFs has been the difficulty in preparing these compounds on an industrial scale, in a cost-effective, safe and environmentally-friendly manner. Mechanochemical processes, in which reactants are combined by mechanical forces, such as extrusion, milling or grinding, have gained increasing interest, as they can reduce or eliminate the use of toxic solvents and minimise chemical waste.

WO2007/023295A2 (incorporated herein in its entirety) discloses processes for the preparation of MOFs by grinding, such as in a ball mill, wholly or substantially in the absence of a solvent. WO2014/191725 (incorporated herein in its entirety) discloses the preparation of MOFs by extrusion. The extrusion process can be a continuous process, allowing high yields of MOFs to be produced in large quantities.

Magnesium formate has been investigated as a useful MOF, due to its ability to adsorb gases. Processes for the preparation of magnesium formate-based MOFs are known.

U.S. Pat. No. 8,343,261 B2 discloses the solution-based preparation of a MOF comprising magnesium formate acetate, in which the MOF is prepared in N,N-dimethylformamide (DMF).

US2012/0016160 A1 discloses a solution-based process for the preparation of a magnesium formate-based MOF, in which liquid formic acid functions as both reagent and solvent.

However, known processes suffer from difficulty in achieving consistently high BET surface areas (i.e. >500 m²/g), with the resulting MOFs often being of variable quality. Other issues can include lengthy production times, batch processing, the requirement for relatively large volumes of solvent and the requirement to isolate the MOFs, for instance by filtration. Poor yields can also be an issue.

It is an object of the present invention to provide an improved process for the preparation of a magnesium formate-based MOF. Ideally, an improved process should be capable of providing a MOF with consistently high surface areas, and, in some cases, with increased efficiency in terms of complexity, materials, safety, time, cost or energy compared with known processes. A reduction in solvent usage and/or the ability to run a continuous process would also be advantageous. An increase in yield of the MOF would be particularly advantageous.

According to the present invention there is provided a process for preparing a magnesium formate-based metal organic framework material, the process comprising:

(a) combining magnesium or magnesium oxide with formic acid;
(b) heating the reaction mixture of step (a) at a temperature of between 70° C. and 200° C.;
(c) combining formic acid with the reaction mixture of step (b); and
(d) heating the reaction mixture of step (c) at a temperature of between 70° C. and 200° C.

Advantageously, the inventors have determined that when formic acid is introduced to the reaction mixture after the first heating step, that yield of the MOF can be improved.

In step (a) of the process, magnesium or magnesium oxide, and formic acid (methanoic acid) are combined. Preferably, this involves the addition of formic acid to magnesium oxide. The molar ratio of the formic acid to magnesium oxide in step (a) is preferably in the range of from 0.3:1 to 5:1, more particularly 0.4:1 to 4:1. In an embodiment, the molar ratio of formic acid to magnesium oxide is from 0.5:1 to 3:1. The formic acid may be added to the magnesium oxide in a single dose, or in one or more sequential doses. For instance, the formic acid can be added in sequential doses spaced apart by intervals in the range of 1 minute to 2 hours, and preferably in the range of 15 minutes to 70 minutes, or 30 minutes to 60 minutes.

In an embodiment, the combining step is carried out with mixing or milling of the reactants. For example if the process is a solution-based method, then the addition may be carried out with stirring of the reactants. Alternatively, if the process is a mechanochemical process, step (a) may be carried out with grinding or milling of the reactants.

In an embodiment of the invention, step (a) is performed by mixing, grinding or milling of the reactants for up to 5 hours, and preferably for up to 2 hours. However, the length of time is not particularly limited, once the reactants are fully combined, and reaction will take place at very low combining times (i.e. almost instantaneously). In an embodiment, step (a) is performed by mixing, grinding or milling of the reactants for from >0 minutes to 5 hours, >0 minutes to 2 hours, from 1 minute to 2 hours, or from 5 minutes to 90 minutes.

In an embodiment, step (a) of the process is carried out at room temperature. However, step (a) may be carried out at a temperature in the range of −20° C. to 101° C., and preferably in the range of 10° C. to 101° C., or 12° C. to 101° C. (the boiling point of formic acid).

After the magnesium oxide and formic acid are combined in step (a), the reaction mixture is heated at a temperature of between 70° C. and 200° C. Preferably, the reaction mixture is heated at a temperature of between 90° C. and 180° C. and more preferably between 111° C. and 180° C., or 115° C. and 180° C. According to an embodiment of the present invention, the reaction mixture is heated at a temperature of between 120° C. to 140° C. In an embodiment, the heating is carried out for at least 30 minutes, preferably for between 1 hour and 24 hours, more preferably for between 3 hours and 20 hours. For convenience, the heating may be carried out overnight (˜15-18 hours). The heating can be carried out by any suitable means known in the art. For instance, when the reactants are combined in a ball mill or planetary mill, the reactants may be removed from the mill and heated by any conventional means, such as in an oil bath. When the reactants are combined in an extruder, the heating may be performed in the extruder. In an embodiment, the heating is carried out under vacuum. However, this is not essential, and the heating can be carried out in air at atmospheric pressure. The means of heating is not particularly limited, and the inventors have determined that the same results are achieved, irrespective of the means used to perform the heating step.

After heating in step (b), formic acid is added to the reaction mixture in step (c). Formic acid is preferably added in an amount of from 0.5 to 5 ml of formic acid per gram of reaction mixture. The formic acid can be added in a single dose, or in one or more sequential doses. The volume of the doses of the formic acid is not particularly limited and will depend on the scale of the reaction and the overall amount of formic acid being added. For instance, the doses can range from 0.2 ml/g to 5 ml/g, and for instance from 0.6 ml/g to 1.87 ml/g.

In an embodiment, the combining step (c) is carried out with mixing or milling of the reactants. When the formic acid is added in more than one dose, step (c) may comprise grinding, mixing or milling the reactants for a period of time between doses. For instance, the formic acid can be added in sequential doses spaced apart by intervals in the range of 1 minute to 2 hours, and preferably in the range of 15 minutes to 70 minutes, or 30 minutes to 60 minutes. For example if the process is a solution-based method, then the addition may be carried out with stirring of the reactants. Alternatively, if the process is a mechanochemical process, step (c) may be carried out with grinding or milling of the reactants. In an embodiment of the invention, step (c) is performed by mixing, grinding or milling of the reactants for up to 5 hours, for instance for up to 2 hours, from >0 minutes to 5 hours, from >0 minutes to 2 hours, from 1 minute to 2 hours, from 5 minutes to 90 minutes etc., with the formic acid being added in one or more doses during this time. However, the length of time is not particularly limited once the reactants are fully combined, and step (c) may be performed for a longer period of time when the reaction is solution-based, rather than mechanochemical.

After the formic acid is added in step (c), the reaction mixture is again heated at a temperature of between 70° C. and 200° C., or between 90° C. and 200° C., in step (d). Preferably, the reaction mixture is heated at a temperature of between 111° C. and 180° C., or between 115° C. and 180° C. Preferably, the reaction mixture is heated at a temperature of between 120° C. to 140° C. While the temperature range for step (d) can be the same as for step (b), there is no requirement that steps (b) and (d) be carried out at the same temperature.

The heating is carried out for at least 30 minutes, preferably for between 1 hour and 24 hours, more preferably for between 3 hours and 20 hours. For convenience, the heating may be carried out overnight (˜15-18 hours). Again, the means of heating the reaction mixture is not particularly limited, and any suitable method can be used. For instance, when the reactants are combined in a ball mill or planetary mill, the reactants may be removed from the mill and heated by any conventional means, such as in an oil bath. When the reactants are combined in an extruder, the heating may be performed on the extruder. The heating may be under vacuum or in air at atmospheric pressure. As for step (b), the means of heating is not particularly limited, and the inventors have determined that the same results are achieved, irrespective of the means used to perform the heating step.

After heating step (d), the magnesium formate-based MOF is obtained. Advantageously, the product is ready for use, and no isolation, purification or other steps are required.

In an embodiment, formic acid can be added to the product of step (d), and the product heated at a temperature between 70° C. and 200° C., i.e. steps (c) and (d) can essentially be repeated, leading to further increases in yield and BET surface areas for the MOFs obtained. In an embodiment, steps (c) and (d) are repeated up to 5 times. In embodiments, steps (c) and (d) are repeated 2, 3 or 4 times. The inventors have demonstrated that yield and surface area of the resulting MOFs can be further improved when steps (c) and (d) are repeated.

In an embodiment, at least one of steps (a) and (c) is a mechanochemical step.

By a “mechanochemical” step it is meant that the mixing or combining of the reactants is performed by the application of mechanical energy, such as by grinding, milling or extrusion. In an embodiment, at least one of steps (a) and (c) is performed by combining the reactants via the application of mechanical energy, such as by grinding, milling or extrusion. Optionally, both of steps (a) and (c) are performed by mechanochemical means. In an embodiment, steps (b) and/or (d) can also be carried out while the reactants are being mechanochemically combined. Optionally, the process can be performed as a continuous process, which may be a mechanochemical process, for example extrusion.

In an embodiment of the invention, step (a) is performed by grinding the magnesium oxide and formic acid in a shaker mill or planetary mill. In an embodiment, step (c) is performed by grinding the product of step (b) in a shaker mill or planetary mill. In an embodiment of the invention, both of steps (a) and (c) are performed by grinding the magnesium oxide and formic acid in a shaker mill or planetary mill. In an embodiment, step (a) is performed by combining the magnesium oxide and formic acid in an extruder. In an embodiment, step (c) is carried out by combing formic acid with the reaction mixture of step (b) in an extruder. In an embodiment, both of steps (a) and (c) are carried out in an extruder. In an embodiment, steps (b) and/or (d) can also be carried out in an extruder. Subsequent repeating of steps (c) and (d) can be carried out in the same manner. In an embodiment, all steps can be performed in an extruder. In an embodiment, the process is a continuous process.

The invention will now be described by way of examples, which are not intended to limit the scope of the invention, but are illustrative only.

### EXAMPLES

Formic acid (product code 33015) and Magnesium Oxide (product code 220361) were obtained from Sigma-Aldrich.

BET Surface Areas were measured by adsorbing N₂ gas onto a sample of Mg Formate at 77K over a range of partial pressures using a BELSORP Mini II apparatus. The values of volume of N₂ adsorbed as a function of N₂ partial pressure were used to calculate the BET surface area using the well known BET Equation.

### Example 1: Small-Scale Production in a Stainless Steel Shaker Mill

In a first example, a magnesium formate-based MOF was prepared in a stainless steel Shaker Mill (Retsch MM400), as follows:

1 gram of magnesium oxide and 1.87 mls of formic acid were milled in a 25 ml vessel with a 15 mm grinding ball at 30 Hz for 30 minutes. The mixture was then dried at 130° C. under vacuum in a round-bottomed flask in an oil bath for 4 hours. 1.4 mls of formic acid was then introduced, and the mixture was milled at 30 Hz for 30 minutes. The resulting mixture was dried at 130° C. overnight.

2.27 g of magnesium formate MOF was produced, which exhibited a BET surface area of 513 m²/g.

### Example 2: Larger-Scale Production in a 250 ml Stainless Steel Planetary Mill

A magnesium formate-based MOF was prepared in a stainless steel Planetary Mill (Retsch PM100) as follows:

25 g of magnesium oxide and 15 mls of formic acid were milled in a 250 ml planetary mill vessel, with two 63 g grinding balls at 400 rpm for 30 minutes. Then, 15 ml of formic acid was introduced into the vessel, and the mixture was milled at 400 rpm for a further 30 minutes. A further 15 ml of formic acid was then introduced, and again the mixture was milled at 400 rpm for 1 hour. The mixture was then dried overnight, at 130° C. Following drying, 15 ml of formic acid was introduced and the mixture was milled at 400 rpm for 30 min. A further 15 ml of formic acid was added, and the mixture was milled at 400 rpm for 30 minutes. The product was then milled at 400 rpm for another 30 minutes. The mixture was then dried overnight, at 130° C. The BET surface area after the second drying step was 460 m²/g. Following drying, 15 ml of formic acid was added, and the mixture was milled at 400 rpm for 30 minutes. A further 15 mls of formic acid was added and the mixture was milled at 400 rpm for 30 minutes. The product was then milled at 400 rpm for another 30 minutes. The mixture was then dried overnight at 130° C.

55 g of magnesium formate MOF was produced, which exhibited a BET surface area of 544 m²/g.

### Example 3: Extrusion

A magnesium formate-based MOF was prepared by extrusion, as follows:

40 g of MgO was mixed with 75 mL of formic acid to form a solid mixture. This was then manually fed into a ThermoFisher Process 11 extruder, at a screw speed of 150 rpm. The barrel of the extruder was 20° C. The extrudate was collected and dried overnight under vacuum at 130° C. BET surface area of the product was determined to be 250 m²/g. 50 ml of formic acid was added to the product, which was passed through the extruder a second time under the same conditions. Again, the extrudate was collected and dried overnight under vacuum at 130° C. BET surface area of the product was determined to be 32 m²/g). 12 ml of formic acid was added, and the product was passed through the extruder a third time under the same conditions as previously, before the extrudate was again collected and dried overnight under vacuum at 130° C. The BET surface area after the third drying step was 445 m²/g, corresponding to commercially viable MOFs, which are marketed with a specification of 400-600 m²/g. It is likely that a further pass through the extruder would have allowed a BET surface area of >500 m²/g to be achieved.

The MgO used in the examples above has a maximum surface area of 165 m²/g. Higher surface areas are therefore indicative of the formation of the desired MOF. The above results therefore demonstrate that when formic acid is introduced to the reaction mixture after the initial reaction between the magnesium oxide and formic acid has taken place, that the yield of the MOF can be improved, and that sequential performance of these formic acid addition/heating steps, can lead to increasingly improved results. This is significant particularly for continuous processes, such as mechanochemical processes, as it allows a direct route to a commercially viable high-surface area MOF at high yields.

1. A process for preparing a magnesium formate-based MOF, the process comprising:
(a) combining magnesium or magnesium oxide with formic acid;
(b) heating the reaction mixture of step (a) at a temperature of between 70° C. and 200° C.;
(c) combining formic acid with the reaction mixture of step (b); and
(d) heating the reaction mixture of step (c) at a temperature of between 70° C. and 200° C.

2. The process according to claim 1, wherein step (a) comprises combining magnesium oxide with formic acid.

3. The process according to claim 1, wherein step (b) is performed at a temperature of between 90° C. and 180° C.

4. The process according to claim 1, wherein step (d) is performed at a temperature of between 90° C. and 180° C.

5. The process according to claim 3, wherein step (b) is performed at a temperature of between 115° C. and 180° C.

6. The process according to claim 4, wherein step (d) is performed at a temperature of between 115° C. and 180° C.

7. The process according to claim 1, wherein step (b) is carried out for between 1 hour and 24 hours.

8. The process according to claim 1, wherein step (d) is carried out for between 1 hour and 24 hours.

9. The process according to claim 1, wherein at least one of step (a) and step (c) is performed with a step selected from grinding, milling, and mixing of the reactants.

10. The process according to claim 9, wherein at least one of step (a) and step (c) is performed with a step selected from grinding, milling, and mixing the reactants for up to 2 hours.

11. The process according to claim 1, wherein at least one of steps (a) and (c) is a mechanochemical step.

12. The process according to claim 11, wherein both (a) and (c) are mechanochemical steps.

13. The process according to claim 12, wherein at least steps (a) and (c) are performed on an extruder.

14. The process according to claim 13, wherein the process is a continuous process.

15. The process according to claim 1, wherein steps (c) and (d) are repeated up to 5 times.
